(19) United States
(12) Patent Application Publication
(10) Pub. No.: US 2001/0014160 A1
(43) Pub. Date: Aug. 16, 2001

(54) SOUND FIELD CORRECTION CIRCUIT

(76) Inventor: YOSHIMICHI MAEJIMA, KANAGAWA (JP)

Correspondence Address: FROMMER LAWRENCE & HAUG, 745 FIFTH AVENUE, NEW YORK, NY, 10151, US

(21) Appl. No.: 09/081,370

(22) Filed: May 19, 1998

(30) Foreign Application Priority Data
May 29, 1997 (JP) 9-140188

(51) Int. Cl. H04R 5/00

(52) U.S. Cl. 381/23; 381/22; 381/1; 381/17

(57) ABSTRACT

The invention provides a sound field correction circuit for a surround playback apparatus wherein a decoding circuit is formed from a comparatively simple circuit and similar effects to those of a ordinary sound field correction circuit can be achieved at a reduced cost. A sound field correction circuit includes a decoding circuit for restoring 2-channel stereo signals encoded for a multi-channel surround effect to obtain multi-channel surround signals. The decoding circuit includes an adder for adding the encoded 2-channel stereo signals to each other, a subtractor for subtracting one of the encoded 2-chhanel stereo signals from the other, a level adjusting volume for adjusting the output level of the adder, and another level adjusting volume for adjusting the output level of the subtractor. An output of the level adjusting volume is used as a center channel signal while an output of the level adjusting volume 6 is used as a surround channel signal.

### BACKGROUND OF THE INVENTION

1. Field of the Invention

This invention relates to a sound field correction circuit for a surround acoustic system, and more particularly to simplification of a decoding circuit for obtaining multi-channel surround signals from 2-channel stereo signals encoded for a multi-channel surround effect.

2. Description of the Related Art

It is known that a human being orients a sound source, in a low-pitched sound region, based on a time difference and/or phase difference between sounds arriving at the two ears, but in a high-pitch sound region, based on a strength difference between incoming sounds to the two ears.

Also it is known that a human being blends sounds from a plurality of sound sources to form a single sound image on the sense of hearing of the human being.

In this instance, the sounds are liable to be blended where the signals of the sound sources have coherency thereamong and the times of the signals are limited to a certain range. The orientation of a composite sound image where two coherent sound sources are involved depends upon the level difference or the time difference between the sound source signals and appears substantially intermediately between the two sound sources. In the meantime, where the sound sources have opposite phases, the sound image is produced in the inside of the head or in the back of the head.

Meanwhile, in such a case wherein, in addition to a direct sound from a sound source, a large number of succeeding sounds such as reflected sounds from walls, a floor and so forth are conveyed to the two ears, the extensity of sound or the distance of the sound source increases. Particularly if reflected sound from sidewardly becomes large comparing with the direct sound, then the extensity of the sound image increases.

An available one of systems wherein the feeling of movement is emphasized using a rear speaker or the like in order to improve the presence of played back sound making use of such a nature as described above is a surround system.

The surround system generally is an acoustic system wherein, in addition to sounds of left and right speakers for providing an original stereo effect, a sound of a sub speaker placed at a different position is played back.

While the surround system is similar to a 4-channel stereo system in that a speaker in addition to left and right speakers is used, it is quite different in that contents of a sound signal recorded on an original source such as, for example, a record or a video tape are not such special ones as in the 4-channel stereo system, but may be such signals as recorded very ordinarily in a stereo system.

In other words, the surround system is free in terms of the detailed method or measures and does not require such a provision or consent that the method or measures must be such and such, only if a purpose of a person who tries to enjoy the sound is satisfied.

Therefore, what is significant is the purpose of a person who tries to enjoy the sound, and roughly speaking, such possible purposes are divided into the following two purposes:

1) Reproduction of an audio signal of a video tape is intended principally, and the purpose is a theater effect wherein played back sound corresponding to an image is made real sound conforming to the image; and

2) Basically a relationship to a picture is not taken into consideration, and the purpose is conscientious reproduction of a sound field at a site such as a hall where the music was recorded.

By the way, the problem is what sound should be produced so that any of such purposes as described above can be achieved.

In the case of 1) above, while depending upon the scene of an image, reproduction of the position of a sound source or of the feeling of movement is comparatively effective.

Meanwhile, in the case of 2), a sound source does not move, and it is necessary to conscientiously reproduce an acoustic condition of a place where the sound was recorded, that is, the length or the magnitude of reverberation and frequency components included in the reverberation Where the purpose is 1) above, if it is assumed that an image includes a scene in which it thunders, then it is more real if the thunder sounds from above, and what is required here is to attach, although depending upon the scene, greater importance to the position or the distance to a sound source or the feeling of movement.

From such a point of view as described above, the reproduction just described is basically impossible with stereo signals recorded by an ordinary method, and a source with which sound was collected, upon recording, using some suitable discretion is more advantageous.

As a representative one of such surround systems as described above, a Dolby pro-logic surround system is available.

The Dolby pro-logic surround system is a modification to a Dolby surround system, which originally is an acoustic system for a movie theater, in that it employs front three channels (L: Left, C: Center, R: Right) and a rear one channel (S: Surround) so as to make an acoustic system for enjoyment of a movie for domestic use.

In such a multi-channel surround system as just described, multi-channel signals are normally encoded once into and recorded in 2 channels onto a recording medium, and then, on a playback equipment side, 2-channel signals from the recording medium are decoded into multi-channels to produce multi-channel surround signals.

Further, when it is tried to play back the thus decoded multi-channel surround signals into front 2-channel surround signals for an ordinary stereo apparatus, the multi-channel surround signals are further converted into signals of 2-channels by a circuit called virtualizer to reproduce them.

A sound field correction circuit which converts 2-channel audio signals first into multi-channel surround signals and then into front 2-channel surround signals generally has such a construction as shown in FIG. 1.

Stereo signals Lt, Rt encoded for a multi-channel surround effect are first sent to a decoder 1.

Then, the stereo signals Lt, Rt are converted from 2-channel signals back into multi-channel signals (for example, L: left channel signal, C: center channel signal, R: right channel signal, S: surround channel signal) in the decoder 1. The resulting multi-channel signals are sent to a virtualizer circuit 2.

The virtualizer circuit 2 is a circuit which processes an audio signal so that, while it performs front 2-channel playback, sound is sounded from around or from backwardly of the ears of a listener as if a surround component S were actually present.

By the way, in such a ordinary sound field correction circuit as described above, decoding of signals of a 2-channel source to multi-channel signals is realized by performing complicated matrix processing by a decoding circuit called surround processor.

The decoding circuit is a combination of a plurality of delay circuits or phase shifters and produces a sum signal and/or a difference signal between an original signal and a signal obtained by performing a delaying process or a phase shifting process for the original signal to enrich the extensity of sound, the distance feeling of a sound image, the feeling of movement of the position of the sound image and so forth.

Since the decoding circuit performs such complicated processes, where a ordinary decoding circuit is employed, the scale becomes large at all, and the cost for the entire apparatus becomes expensive.

In the ordinary sound field correction circuit for use with a playback apparatus for playback of surround signals described above, since a complicated matrix process is performed by a circuit for decoding, there is a drawback in that the circuit becomes large in scale at all and consequently the apparatus becomes expensive.

### SUMMARY OF THE INVENTION

It is an object of the present invention to provide a sound field correction circuit for a surround playback apparatus wherein a decoding circuit is constructed using a comparatively simple circuit and effects equivalent to those of such a ordinary sound field correction circuit as described above can be achieved at a low cost.

In order to attain the object described above, according to the present invention, there is provided a sound field correction circuit which receives signals of at least 2 channels encoded for a multi-channel surround effect as input signals and outputs multi-channel surround signals, comprising inputting means for receiving at least a first signal and a second signal encoded for a multi-channel surround effect as input signals, and decoding means for decoding the first and second signals to produce multi-channel surround signals, the decoding means including addition means for adding the first and second signals to produce a sum signal, and subtraction means for subtracting the second signal from the first signal to produce a difference signal.

The decoding means may further include sum signal level adjustment means for receiving the sum signal, adjusting a level of the sum signal and outputting the sum signal of the adjusted level, and difference signal level adjustment means for receiving the difference signal, adjusting a level of the difference signal and outputting the difference signal of the adjusted level.

In the sound field correction circuit, the decoding circuit for restoring first and second signals such as 2-channel stereo signals encoded for a multi-channel surround effect to obtain multi-channel surround signals is formed from the addition means and the subtraction means to which the first and second signals are inputted, and the sum signal level adjustment means and the difference signal level adjustment means for adjusting the output levels of the addition means and the subtraction means.

Consequently, with the sound field correction circuit, a surround effect which provides the presence of such a degree that there is little problem in practical use can be realized at a very low cost. Further, the sound field correction circuit can be utilized advantageously to a field of, for example, TVs and video tape recorders, acoustic apparatus of the portable type, models of low prices and so forth which do not require a very high sound quality different from audio apparatus.

Furthermore, where noise reduction of the Dolby deformation B type is performed for the difference signal between the first and second signals from the subtraction means, noise in the playback stage can be reduced significantly, and a surround playback signal which is easy to listen to and is full of the presence is obtained.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram of a sound field correction circuit which converts 2-channel signals into multi-channel surround signals and then into front 2-channel surround signals;

FIG. 2 is a circuit block diagram of a sound field correction circuit to which the present invention is applied;

FIG. 3 is a similar view but showing a modification of the sound field correction circuit shown in FIG. 2;

FIG. 4 is a similar view but showing another sound field correction circuit to which the present invention is applied; and

FIG. 5 is a diagram illustrating a noise suppression effect by noise reduction of the Dolby B type.

### DESCRIPTION OF THE PREFERRED EMBODIMENTS

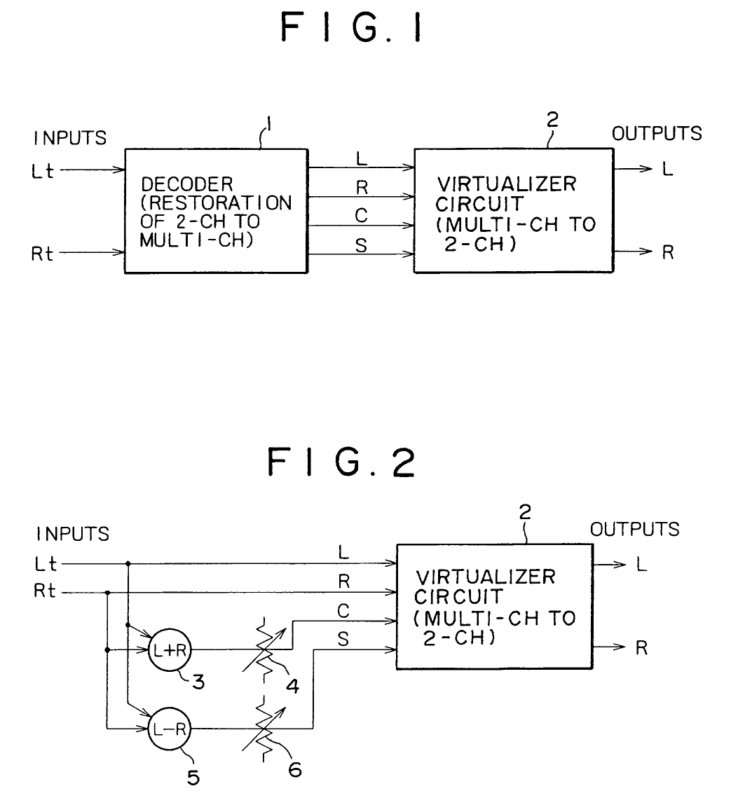

Referring first to FIG. 2, there is shown in circuit block diagram of a sound field correction circuit to which the present invention is applied. The sound field correction circuit shown includes a virtualizer circuit 2, an adder 3, a subtractor 5, and a pair of level adjusting volumes 4 and 6.

In the sound field correction circuit, input stereo signals Lt, Rt are first sent as L (left channel) and R (right channel) signals directly to the virtualizer circuit 2.

The input stereo signals Lt, Rt are sent also to the adder 3 and the subtractor 5. Then, the adder 3 adds the stereo signals Lt and Rt (=Lt+Rt) to produce a C (center channel) signal while the subtractor 5 calculates the difference between the stereo signals Lt and Rt (that is, Lt−Rt) to produce an S (surround channel) signal. Each of the adder 3 and the subtractor 5 can be formed readily from an amplification circuit which may employ, for example, an operational amplifier.

The L (left channel), R (right channel), C (center channel) and S (surround channel) signals obtained in this manner are sent to the virtualizer circuit 2 so that front 2-channel surround signals are obtained by processing of the virtualizer circuit 2.

However, if the C (center channel) and S (surround channel) signals are supplied directly in this manner, then since the input gains of them to the virtualizer circuit 2 are fixed, the drawback that the resulting sound lacks in balance is presented. In order to adjust the signals to obtain sound which is easy to listen to, the level adjusting volumes 4 and 6 are provided on the outputs of the adder 3 and the subtractor 5, respectively, and the volume amounts of them are adjusted relative to each other so that well-balanced easy-listening sound is obtained.

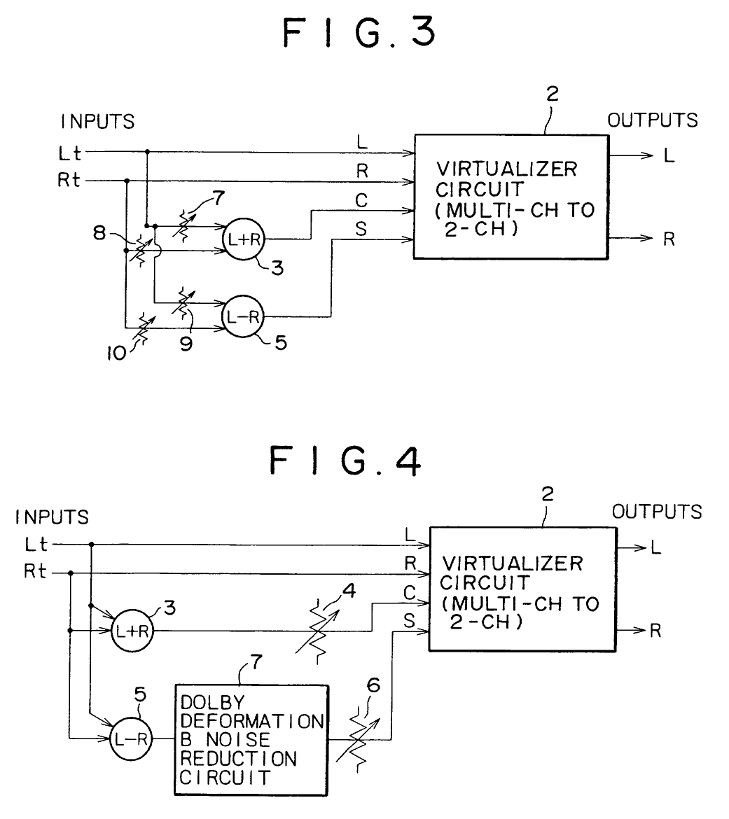

The sound field correction circuit described above with reference to FIG. 2 may be modified in such a manner as shown in FIG. 3. In particular, referring to FIG. 3, the modified sound field correction circuit includes, in place of the level adjusting volumes 4 and 6 connected to the output sides of the adder 3 and the subtractor 5, volumnes 7 and 8 and volumes 9 and 10 connected to the input sides of the adder 3 and the subtractor 5, respectively. More particularly, the input stereo signals Lt, Rt are first adjusted in volume amount by the volumes 7 and 8, respectively, and then inputted to the adder 3. Meanwhile, the input stereo signals Lt, Rt are also adjusted in volume by the volumes 9 and 10, respectively, and then inputted to the subtractor 5. The outputs of the adder 3 and the subtractor 5 are inputted directly to the virtualizer circuit 2.

By the way, in such a decoder 1 as shown in FIG. 1, a directionality emphasis circuit formed from a plurality of delay circuits and phase-shifting circuits, a matrix circuit and so forth is incorporated so that a sufficient feeling of movement and presence can be obtained.

However, since also the original stereo signals have been recorded originally so that a feeling of movement may be provided, even if the decoding circuit is simplified as in the present invention, an effect proximate to an intended effect can be obtained.

Referring now to FIG. 4, there is shown in circuit block diagram another sound field correction circuit to which the present invention is applied.

Among various surround systems, the Dolby surround system is most spread popularly at present.

In the Dolby surround system, in order to improve the S/N ratio of the surround channel S, a Dolby deformation B noise reduction process is performed for the surround channel S. In this method, reduction of playback noise is performed using a method of making the level upon recording and the level upon playback different from each other.

A process equivalent to this is performed, in the present embodiment, by a Dolby deformation B noise reduction circuit 7.

Where the noise reduction circuit 7 is inserted in this manner, natural sound which is superior in SIN ratio can be reproduced.

Here, a noise reduction circuit for noise reduction of the Dolby B type is described briefly.

The noise reduction circuit is used for a recording system for a cassette tape. That noise which is suppressed by the noise reduction circuit is limited to noise in a playback stage which is generated principally from a tape or a head, but is not that noise which is present upon recording.

The method of removing noise proceeds in the following manner. In particular, prior to recording, only a signal of a low level is automatically changed to a signal of a higher level so that the signal of the higher level may be recorded. Then, upon playback, the playback amplification degree is decreased so that the level of the signal recorded with a higher level is automatically returned to the original level to effect playback conversely to that upon recording. By the method, also noise included in a signal of a low level played back is decreased.

The noise reduction circuit for noise reduction of the Dolby B type is a pioneer one of noise reduction circuits, and most of cassette tapes put on the market at present are encoded by the noise reduction system of the Dolby B type.

In the system, an encoding process for raising the level of a low level signal is not performed for the entire frequency band. In the Dolby B type system, encoding is performed only for frequencies higher than approximately 500 Hz, and an encoding process for raising the level prior to recording and a decoding process for lowering the level upon playback are performed around 1 to 3 kHz on which tape noise appears in a concentrated manner. A special method wherein also the band which makes an object of the process is varied depending upon the signal level is employed.

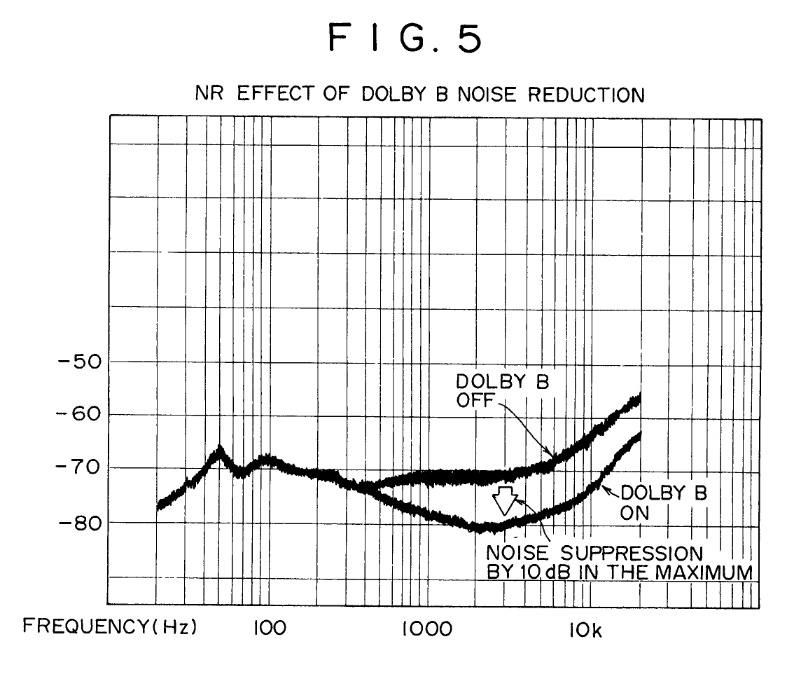

The noise suppression capacity by the Dolby B type noise reduction is 10 db in the maximum as seen from FIG. 5.

Another characteristic of the Dolby B type noise reduction resides in that the purpose is achieved not by performing the operation for raising or lowering the level by changing the amplification degree of the entire amplifier, but by extracting signal components which are included in a band to be processed from an original signal while successively increasing the signal components as the level drops with respect to a boundary provided by a level called Dolby level, adding the signal components to the original signal to intensify the original signal and extracting, upon playback, both of the thus extracted signal components and noise upon playback together with each other from a playback signal.

Since such a method as described above is adopted, as the signal level approaches the Dolby level, the level variation amount in increasing or decreasing the strength decreases and also the noise suppression amount decreases.

However, since this does not make, where the signal level is high, a real loss due to a masking effect by which noise does not make an obstacle and the entire processing amount is small, such breathing reduction that, after sound disappears, noise remains and then disappears from the fact that the gain variation of an amplifier cannot follow up a blow sound which exhibits a quick rise and a short duration.

In order to extract signal components which are in a band to be processed from an original signal while successively increasing the signal components, a unique method is adopted, and a circuit for determining such components to be extracted is not provided separately for both of recording and playback, but a single circuit is used. Consequently, since the components to be extracted, that is, signal components to be added and subtracted, are accurately same ones, the reproduction property of a playback signal with respect to the original signal is very high.

By the way, as described above, in the sound field correction circuit described in the description of the related art hereinabove, when it is tried to obtain front 2-channel surround signals from multi-channel surround signals, a decoder which employs an expensive matrix circuit such as a Dolby pro-logic circuit is used in order to achieve a sufficient effect.

While preferred embodiments of the present invention have been described using specific terms, such description is for illustrative purpose only, and it is to be understood that changes and variations may be made without departing from the spirit or scope of the following claims.

What we claim is:

1. A sound field correction circuit which receives signals of at least 2 channels encoded for a multi-channel surround effect as input signals and outputs multi-channel surround signals, comprising:
inputting means for receiving at least a first signal and a second signal encoded for a multi-channel surround effect as input signals; and
decoding means for decoding the first and second signals to produce multi-channel surround signals;
said decoding means including addition means for adding the first and second signals to produce a sum signal, and subtraction means for subtracting the second signal from the first signal to produce a difference signal.

2. A sound field correction circuit according to claim 1, wherein said decoding means further includes sum signal level adjustment means for receiving the sum signal, adjusting a level of the sum signal and outputting the sum signal of the adjusted level, and difference signal level adjustment means for receiving the difference signal, adjusting a level of the difference signal and outputting the difference signal of the adjusted level.

3. A sound field correction circuit according to claim 1, wherein said decoding means includes first level adjustment means for adjusting the first signal and outputting the first signal of the adjust level to said addition means, second level adjustment means for adjusting the second signal and outputting the second signal of the adjust level to said addition means, third level adjustment means for adjusting the first signal and outputting the first signal of the adjust level to said subtraction means, and fourth level adjustment means for adjusting the second signal and outputting the second signal of the adjust level to said subtraction means.

4. A sound field correction circuit according to claim 2, further comprising a virtualizer for receiving at least the first and second signals, an output of said sum signal level adjustment means and an output of said difference signal level adjustment means and outputting a desired number of channels of surround signals.

5. A sound field correction circuit according to claim 1, wherein said decoding means includes noise reduction means connected to said subtraction means.

6. A sound field correction circuit according to claim 5, wherein said noise reduction means of said decoding means performs Dolby B deformation noise reduction processing.

7. A sound field correction method wherein signals of at least 2 channels encoded for a multi-channel surround effect are received as input signals and multi-channel surround signals are outputted, comprising:
an inputting step of receiving at least a first signal and a second signal encoded for a multi-channel surround effect as input signals; and
a decoding step of decoding the first and second signals to produce multi-channel surround signals;
the decoding step including an addition step of adding the first and second signals to produce a sum signal, and a subtraction step of subtracting the second signal from the first signal to produce a difference signal.

8. A sound field correction method according to claim 7, wherein the decoding step includes a sum signal level adjustment step of receiving the sum signal, adjusting a level of the sum signal and outputting the sum signal of the adjusted level, and a difference signal level adjustment step of receiving the difference signal, adjusting a level of the difference signal and outputting the difference signal of the adjusted level.

9. A sound field correction method according to claim 7, wherein the decoding step includes a first level adjustment step of adjusting the first signal and outputting the first signal of the adjust level to the addition step, a second level adjustment step of adjusting the second signal and outputting the second signal of the adjust level to the addition step, a third level adjustment step of adjusting the first signal and outputting the first signal of the adjust level to the subtraction step, and a fourth level adjustment step of adjusting the second signal and outputting the second signal of the adjust level to the subtraction step.

10. A sound field correction method according to claim 8, further comprising a step of receiving at least the first and second signals, an output of the sum signal level adjustment step and an output of the difference signal level adjustment step and outputting a desired number of channels of surround signals.
